(19) United States
(12) Patent Application Publication
(10) Pub. No.: US 2026/0352485 A1
(43) Pub. Date: Nov. 5, 2026

(54) GUARDIAN MIDDLEWARE AI: THE CRYPTOGRAPHIC CONTROL PLANE FOR TRUSTED AI

(71) Applicant: MiAngel, Inc., Cutler Bay, FL (US)

(72) Inventor: Rafael Mas, Cutler Bay, FL (US)

(21) Appl. No.: 19/385,439

(22) Filed: Nov. 11, 2025

Related U.S. Application Data
(60) Provisional application No. 63/800,255, filed on May 5, 2025.
(60) Provisional application No. 63/865,482, filed on Aug. 17, 2025.

(51) Int. Cl. H04L 9/32; H04L 9/00; H04L 9/08; H04L 9/30

(52) U.S. Cl. CPC H04L 9/3247; H04L 9/0825; H04L 9/30; H04L 9/3213; H04L 9/3231; H04L 9/3236; H04L 9/50

(57) ABSTRACT

A middleware system conditions large-language-model interactions through cryptographically enforced access control, deterministic memory selection, and tamper-evident auditing. A user message is received with a cryptographic attestation that is validated for freshness using a nonce and an expiration timestamp. Private conversational memory is denied by default and enabled only upon successful validation. Candidate memories annotated with sensitivity and retention metadata are scored by a deterministic salience function combining semantic similarity, term specificity, and temporal recency, and identifiers and scores of selected memories are hashed into an audit digest. A canonical control segment encodes an authentication state, a user-state vector, policy identifiers, parameter overrides, a consent scope, and integrity metadata including a digital signature, the segment being validated before transmission. The conditioned input sequence includes the control segment and the message augmented with selected memories. Each interaction is logged in an append-only audit chain linking the control-segment digest with the memory-selection digest to ensure end-to-end integrity.

### CROSS-REFERENCE TO RELATED APPLICATIONS

The present application claims priority to U.S. Provisional Application No. 63/865,482 filed Aug. 17, 2025, and U.S. Provisional Application No. 63/800,255 filed May 5, 2025, each of which is hereby incorporated by reference in its entirety.

### TECHNICAL FIELD

The embodiments generally relate to middleware architectures for conversational artificial-intelligence (AI) systems, and more particularly to a cryptographically enforced middleware control-plane that governs context-aware, attestation-validated communication between users and large-language-model (LLM) services.

### BACKGROUND

Conventional conversational artificial-intelligence (AI) systems rely on large-language-model (LLM) engines that process user inputs together with stored conversational context. Typically, such systems capture prior exchanges as raw transcripts or summaries and inject them directly into later prompts. Authentication, when provided, is limited to user login and does not regulate how stored records are recalled, combined, or reused during inference, leaving no cryptographic linkage between a user's current identity and previously persisted context.

Existing context-retrieval techniques such as vector-embedding similarity, keyword search, or heuristic filtering permit a model to reference earlier dialogue but often yield irrelevant, outdated, or contradictory context. Such retrieval noise increases computational load and degrades response consistency. Metadata like safety indicators, policy constraints, or user states are frequently appended as free-text instructions rather than canonicalized control data, which limits interoperability, standardization, and auditability across sessions.

Conventional safety and personalization mechanisms operate at coarse granularity. Safety filters often rely on keyword matching or fixed rule sets that fail to adapt to varying user risk or intent levels. Personalization directives are typically expressed as high-level tone or style cues rather than structured, verifiable policy definitions. Moreover, most logging occurs only at the transcript level, without cryptographic chaining or tamper evidence, making it difficult to confirm the integrity of stored records or to demonstrate compliance with evolving data-protection requirements.

### SUMMARY

This summary introduces certain concepts of the disclosed technology in simplified form for ease of understanding. It is not intended to identify essential features or to delimit the scope of the claimed subject matter, which is defined by the appended claims.

In one embodiment, a middleware control plane conditions interactions between user devices and external large-language-model (LLM) services. As illustrated in FIG. 1, the middleware includes modules for authentication and attestation (120), signal ingestion (130), user-context storage (140), persona selection (160), salience-based memory processing (180), prompt composition (170), validation (190), and audit logging. The middleware verifies a cryptographic attestation before granting access to private conversational memory, ensuring that sensitive records remain inaccessible unless the attestation is both valid and fresh. This identity-bound gating introduces an authentication layer that governs recall and corrects the absence of such controls in conventional systems.

The middleware applies a deterministic, token-budgeted salience function to candidate memories retrieved from the context store (140). Using semantic similarity, term specificity, and temporal recency, the system deterministically selects a subset of records most relevant to the current interaction. By constraining selection under a defined token budget, the system reduces inference-time computation and mitigates inclusion of irrelevant or contradictory context.

A canonical control segment (174) is generated separately from user input to encode authentication state, user state vectors, policy identifiers, model parameter overrides, and consent scope. Integrity fields such as a cryptographic signature (322), nonce, and expiration bind these elements into a verifiable structure. Before transmission, the middleware validates the segment's integrity, ensuring standardized conditioning and auditability unavailable in prior free-text metadata approaches.

Adaptive safety and personalization are provided through persona-policy packs (160). Each signed and versioned pack defines enforceable decoding overrides, guardrails, and memory constraints. A persona selector dynamically applies an appropriate pack based on the authenticated state, computed risk score, consent scope, or historical patterns, addressing the rigidity of static filters and tone-based personalization found in prior systems.

In another embodiment, each attestation includes a nonce and expiration timestamp validated within a defined freshness window. If validation fails, private conversational memory remains locked and the middleware defaults to a restricted persona mode. Every interaction produces two cryptographic digests a control-segment digest (176) and a memory-selection digest (182) which are chained together within an append-only audit ledger (790).

The disclosed architecture improves the functioning of computer systems interfacing with LLMs by cryptographically enforcing identity, consent, and deterministic context selection prior to inference. These mechanisms reduce unauthorized data access, lower computational load, and provide verifiable auditability unattainable through manual or purely procedural safeguards.

Each interaction results in a tamper-evident audit record (790) whose digests of memory selections and control segments are cryptographically linked across sessions. Optionally, aggregated ledger roots (902) are anchored to external timestamp or blockchain services (910), as depicted in FIG. 9, thereby enabling long-term integrity verification and regulatory compliance.

Additional embodiments, modifications, and operational variations will become apparent from the detailed description that follows. These variations are illustrative and are not intended to limit the scope of the invention as defined in the claims.

### BRIEF DESCRIPTION OF THE DRAWINGS

A more complete understanding of the embodiments and attendant advantages will be apparent from the following detailed description when read in conjunction with the accompanying drawings, in which:

FIG. 1 is a block diagram of a middleware architecture (100) for authenticated, context-conditioned, and auditable interactions with an external stateless large-language-model (LLM) service.

FIGS. 2A and 2B collectively illustrate a method flow (200) for conditioning an interaction with a large-language-model using middleware controls, including attestation validation, persona selection, and deterministic salience processing.

FIG. 3 is a diagram of a canonicalized, machine-parsable, and cryptographically signed control segment (174) that conditions interactions with a language model.

FIG. 4 is a decision flow diagram of middleware-enforced memory-gating based on cryptographic attestation and a deny-by-default policy.

FIG. 5 illustrates a salience-driven write-back and memory-update flow that is attestation-gated and auditable.

FIG. 6 is a schematic of a persona-selection subsystem and associated signed policy packs (160) providing adaptive safety and personalization.

FIGS. 7A and 7B illustrate a risk-escalation policy flow (700) that is attestation-linked and consent-aware, including threshold-based persona adaptation and human-contact escalation.

FIG. 8 illustrates a system environment including a longitudinal affect-analysis pipeline that is attestation-gated and consent-aware.

FIG. 9 depicts an external anchoring process in which aggregated ledger roots (902) are committed to trusted-timestamp or blockchain networks (910) to provide long-term verifiability.

### DETAILED DESCRIPTION

The following description sets forth one or more illustrative embodiments in sufficient detail to enable those skilled in the art to practice the invention. These examples are provided for explanatory purposes and are not intended to limit the scope of the claimed subject matter. Structural and functional alternatives that are obvious to one of ordinary skill are considered within the scope of the disclosed embodiments.

Elements of the embodiments are illustrated in block-diagram or functional form to emphasize key relationships and processes. Conventional hardware and software components known to those skilled in the art are shown schematically or omitted where not essential for understanding the disclosed architecture.

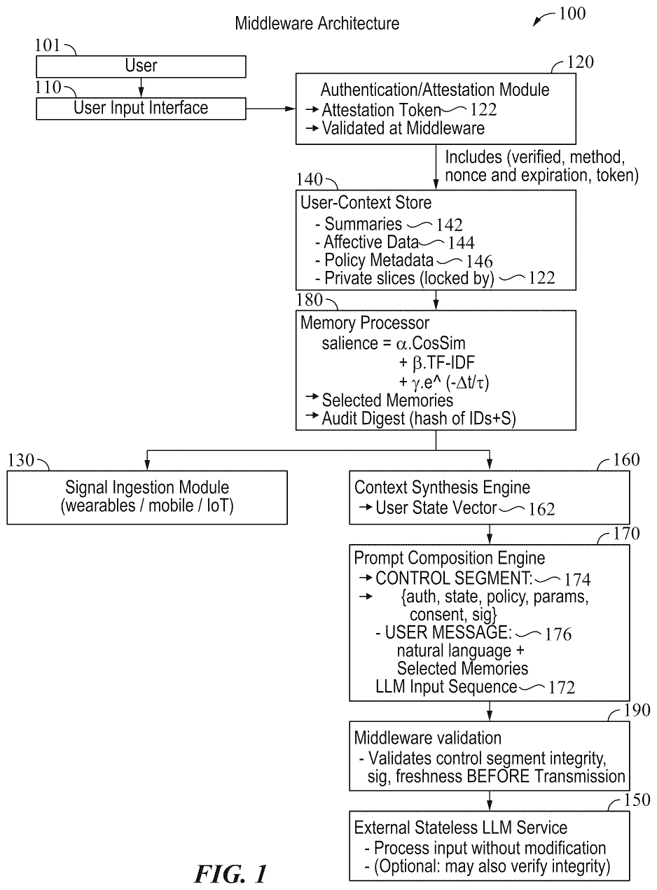

Referring now to FIG. 1, a middleware architecture (100) is positioned between a user interface (10) and an external large-language-model (LLM) service (150). The middleware operates as a coordinated collection of software modules that may execute on distributed servers, cloud containers, or edge devices, with optional client-side agents running on mobile devices, desktops, or wearable hardware. In one embodiment, the middleware is realized as a microservices framework exposing application-programming interfaces (APIs) for authentication (120), signal ingestion (130), state generation (140), and prompt conditioning (170). In other embodiments, a monolithic application may integrate these functions within a single runtime environment.

The user input interface (10) receives natural-language input from the user through one or more channels, such as typed text, voice commands, or embedded chat widgets. For speech input, the interface may employ automatic-speech-recognition engines to convert audio signals into text. The interface can normalize incoming text by performing tokenization, spell correction, or profanity masking. Associated metadata such as input source, timestamp, and device identifier—is captured alongside each message for later inclusion within the control segment (174). In some implementations, the interface also accepts structured signals, for example JSON-formatted control requests, to initiate non-conversational actions.

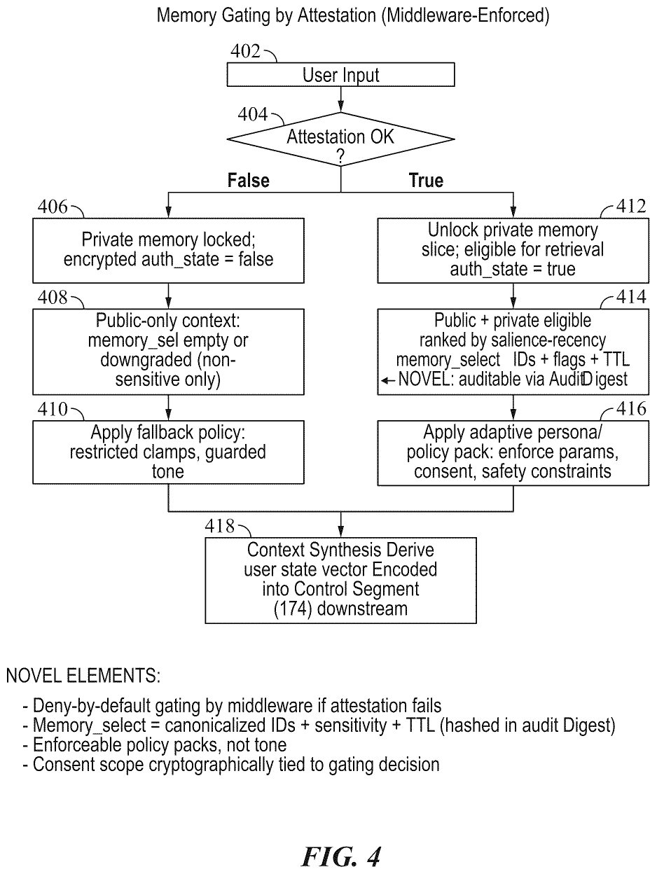

An authentication and attestation module (120) issues cryptographic tokens that validate a user's eligibility to recall private conversational memory. Each token may be derived from biometric signals (e.g., fingerprint, facial geometry, voiceprint) or from device-based keys stored in a trusted platform module (TPM) or secure enclave. Every token includes freshness metadata-a nonce, timestamp (304), and expiration interval verified within a defined freshness window W. The middleware maintains a key registry for validating digital signatures or message-authentication codes embedded in tokens, as reflected in the control segment's AUTH field (306). In certain embodiments, attestation events may be tied to multi-factor authentication, such as time-based one-time passwords or hardware security key interactions. If validation fails, the system defaults to the deny-by-default path shown in FIG. 4.

The DEVICE field (308) may optionally include a device-history subfield (127) that records prior authentication events, device rotations, or trust-level adjustments across sessions, thereby enabling the middleware to detect anomalous device patterns or to enforce stepped-up authentication policies when a user switches between trusted and untrusted endpoints.

A signal ingestion module (130) captures contextual data streams that supplement the user's direct message. For example, a wearable device may supply heart rate, accelerometer readings, or galvanic skin response; a browser client may report page context, cursor activity, or engagement time; and audio or video feeds may be analyzed to extract sentiment, pitch, or facial affective states. The module performs feature extraction and normalization to a standard sampling rate before writing to a time-series store (140) or streaming bus (e.g., Kafka-class middleware). Each signal is processed under the user's consent scope (320) to ensure that only authorized features contribute to state generation and risk analysis. This real-time ingestion pipeline updates user state records for use by the memory processor (180) and persona selector (160) modules of FIG. 1.

A user-context store (140) maintains structured records of prior interactions, including conversation summaries produced by embedding models, affective-state vectors, and metadata such as creation time and retention policy. Each record may be encrypted with symmetric keys and indexed within a vector-similarity database (e.g., FAISS-class or Pinecone-class system) for efficient retrieval. Each record carries sensitivity metadata specifying whether it is accessible only after successful attestation validation (120) or under restricted persona policies (160). In certain embodiments, context data are partitioned into short-term caches and long-term archives that apply differential retention and encryption strategies, enhancing privacy protection and query performance.

A memory-processor (180) computes deterministic salience scores to select which context records are incorporated into a current interaction. The processor applies a composite scoring function combining: (i) semantic similarity based on cosine distance between record embeddings and the active query, (ii) term specificity derived from TF-IDF weighting, and (iii) a temporal-recency decay that prioritizes recent interactions. The processor iteratively accumulates records until a predefined token budget (B) is reached, thereby optimizing utilization of the model's context window. Identifiers and scores of selected records are hashed (e.g., using SHA-256) to generate a memory-selection digest (182) that later links into the audit chain (790). In alternative embodiments, reinforcement-learning models dynamically adjust thresholds based on user-satisfaction signals. This deterministic salience mechanism reduces latency and compute cost, decreases energy consumption, and lowers hallucination rates by excluding low-relevance or contradictory data.

The memory processor (180) implements a deterministic salience-scoring algorithm to evaluate candidate records retrieved from the user-context store (140). Each candidate record i is represented by an embedding vector Ei, produced by a transformer-based embedding model or functionally equivalent text-encoder network. The embedding of the current user message is denoted Et, and serves as the reference vector for similarity computation within the composite salience function.

A composite salience function deterministically computes a salience score S(i) for each candidate record i according to:

S(i)=α·Sim(E_i, E_t)+β·TFIDF_i−γ·Δt_i

where Sim(E_i, E_t) denotes the cosine-similarity between vectors, TFIDF_i represents the term-specificity weight of record i, and Δt_i is the temporal-recency interval between record creation and the current interaction. Coefficients α, β, and γ are fixed calibration constants selected to balance semantic relevance, specificity, and recency. Because the function operates deterministically on stored embeddings and timestamps, identical inputs yield identical rankings, thereby supporting auditable reproducibility and enforcing the token-budget constraint (B) applied by the memory processor (180).

The memory processor (180) ranks all candidate records by their computed salience score S(i) and iteratively selects the top-ranked k items whose cumulative token length does not exceed a configurable token-budget limit (Tₘₐₓ or B). The resulting subset forms the contextual component of the conditioned-input sequence (172) transmitted to the external large-language-model (150). This deterministic budgeting ensures reproducible context construction and bounded computational load during inference.

In certain embodiments, the memory processor (180) dynamically adapts the weighting coefficients (α, β, γ) based on prior performance metrics such as response accuracy, latency, or user-satisfaction feedback collected in audit logs. Alternative formulations may normalize or transform component terms, for example applying exponential decay to the temporal component Δti or sigmoid normalization to similarity scores. These adaptive variants preserve determinism once parameters are fixed for a session, maintaining the system's auditability while improving relevance over time.

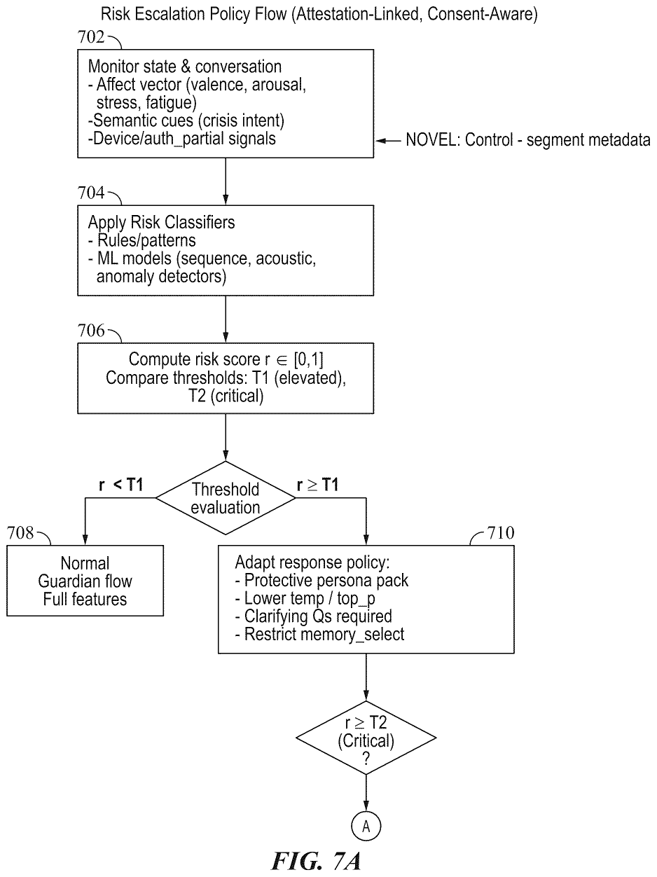

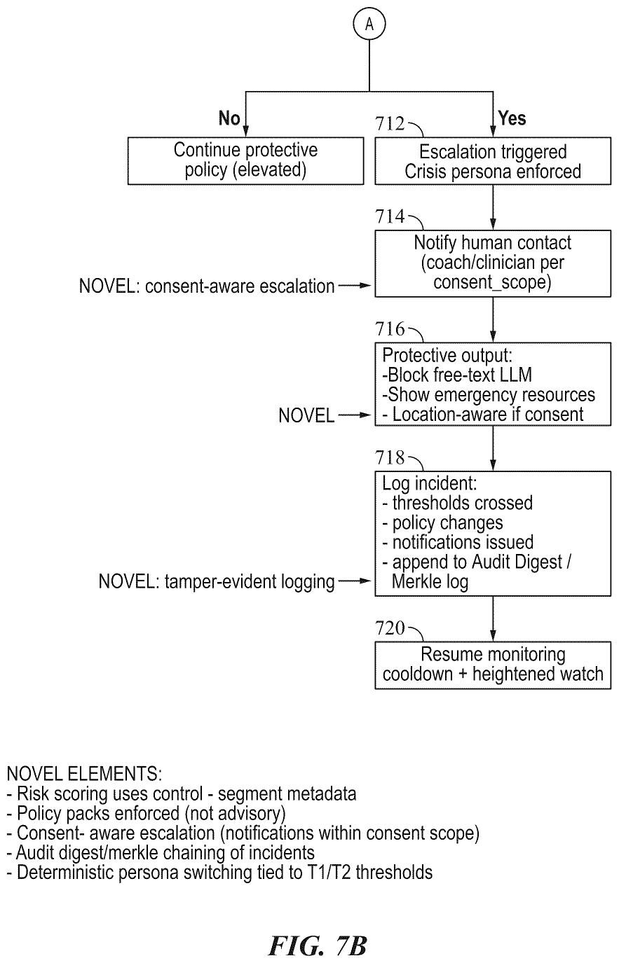

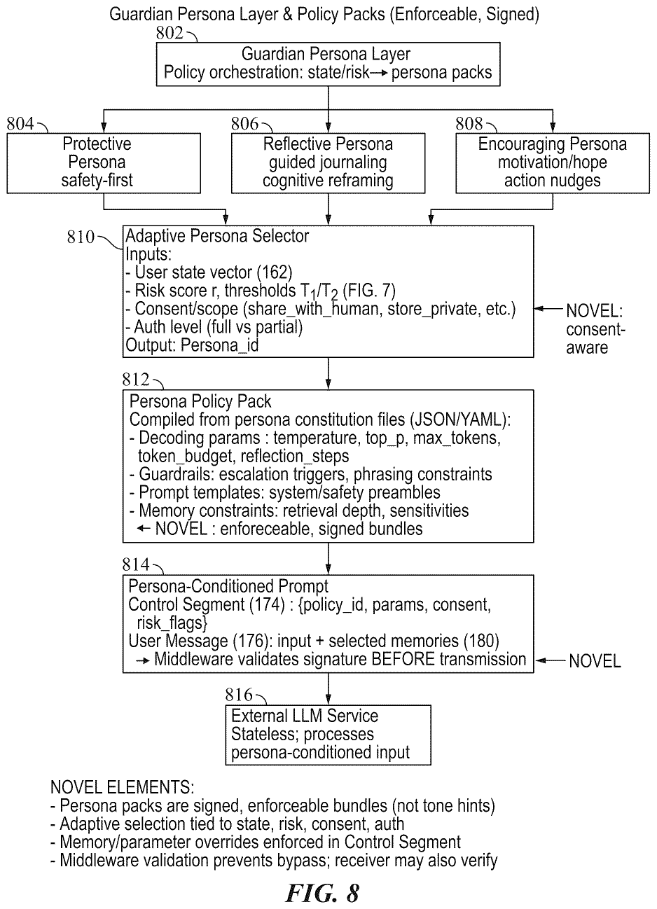

For each interaction, the identifiers and salience scores of the selected records are serialized in canonical order and hashed using a secure algorithm such as SHA-256 to produce a memory-selection digest (182). This digest, together with the control-segment digest (176), provides cryptographically verifiable provenance of context recall and is subsequently appended to the audit chain (790) described in FIG. 7.

A context-synthesis engine (140) aggregates the salience-selected records from the memory processor (180) with current contextual signals from the ingestion module (130) to produce a user-state vector (142). The vector encodes numerical features such as normalized stress indices, sentiment polarity, or arousal level and categorical features such as awake, focused, or distracted. Updates may occur at fixed intervals or dynamically upon significant variation in any monitored signal. In alternative embodiments, the user-state vector is generated by a multimodal transformer that jointly embeds textual, auditory, and physiological inputs into a unified latent representation. This continuously maintained state representation becomes an input field within the control segment (174) used for prompt conditioning.

A prompt-composition engine (170) assembles the final input sequence to be delivered to the external large-language-model (LLM) service (150). The sequence consists of two logical components: (1) a control segment (174) and (2) a user-message segment (172). The control segment is serialized in a canonical, machine-parsable format, for example JSON-LD, CBOR, or Protocol Buffers, and contains fields specifying an authentication state (306), the current user-state vector (310), a policy identifier (314), model-parameter overrides such as temperature or maximum tokens (316), a consent scope (320) governing permissible memory recall, and integrity metadata including cryptographic signature (322). The control segment is consumed and validated exclusively within the middleware layer, which uses it to enforce access policies and to generate audit records. Only the resulting conditioned textual prompt (172) derived from validated data is transmitted to the stateless LLM service. In certain embodiments, the control segment may also be logged or attached as a non-executed header for traceability, but it is not intercepted or authenticated by the LLM itself.

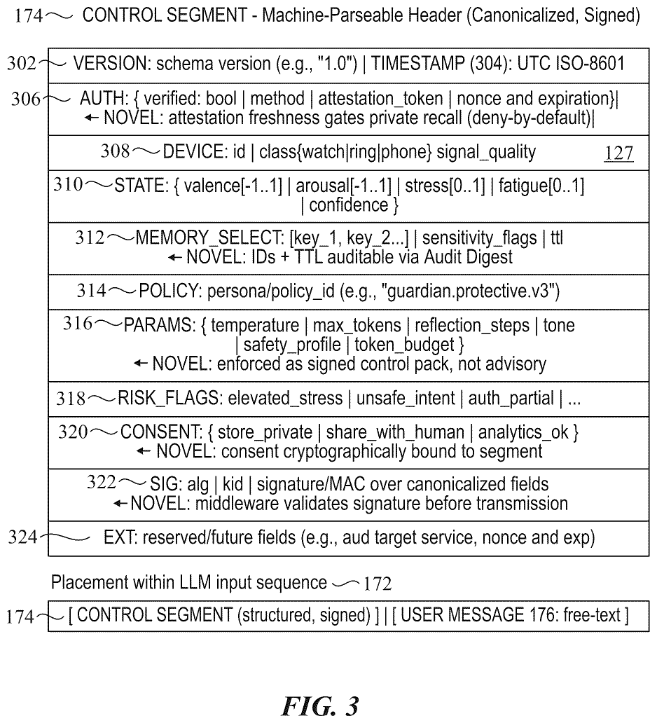

A validation module (190) performs a final integrity and freshness check on every conditioned input sequence (172) before transmission to the external LLM (150). Verification includes confirming the digital signature (322) of the control segment (174), validating freshness metadata nonce and timestamp (304) against the middleware's secure wall-clock, and confirming compliance with the canonical serialization order defined for the control-segment schema (FIG. 3). If any check fails, the middleware blocks access to private memory and enforces a restricted persona mode (160) that operates only on public or sanitized context. For instance, an expired or invalid attestation token triggers fallback to a generic persona while still allowing limited interaction. The validation module logs each verification outcome and associated decision to the audit chain (790) for subsequent compliance review.

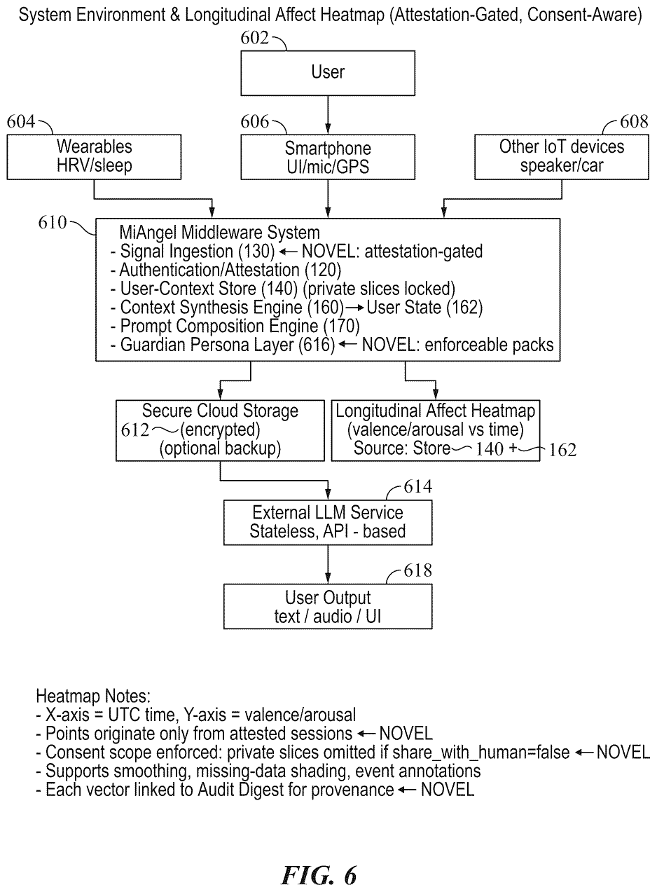

A guardian-persona layer (160) hosts multiple persona-policy packs (162), each defining enforceable configuration parameters that govern model behavior and memory-access scope. Policy packs specify, for example, tone-normalization rules, escalation triggers, and retrieval limits. A protective persona may restrict generated outputs to concise, empathetic phrases and block sensitive recall; a reflective persona may permit richer contextual recall while applying moderation filters; and an encouraging persona may adjust decoding parameters to produce motivational responses. Each policy pack is expressed as a machine-readable definition file (e.g., JSON or YAML) containing fields such as decoding parameters (temperature, top_p), tone modifiers (response_bias), retrieval constraints (max_depth, sensitivity_level), and escalation conditions (risk_threshold). A persona-selector (164) dynamically activates the policy pack whose conditions best match the current user-state vector (142), consent scope (320), or risk score (318). These structured, signed policy packs replace ad-hoc prompt instructions with deterministic, auditable behavior-control logic, as illustrated in FIG. 6.

The guardian-persona layer (160) stores one or more persona-policy packs (162) expressed in machine-readable configuration files. Each policy pack is defined in a structured format such as JSON, YAML, or TOML and specifies behavioral parameters and operational constraints that govern both middleware enforcement and downstream interactions with the LLM (150). Each pack is signed and version-controlled to ensure authenticity and reproducibility, as illustrated in FIG. 6.

Each persona-policy pack (162) may include one or more model-parameter-override fields (316) defining parameters that control text-generation behavior. These fields may include, without limitation, temperature, top_p, max_tokens, token_budget, stop_sequences, presence_penalty, frequency_penalty, and reflection_steps.

Each persona-policy pack (162) may further include guardrail definitions (314) specifying response-shaping constraints. Such guardrails may define permitted phrasing styles, escalation triggers, disallowed content categories, and redaction or formatting requirements to be enforced by the middleware before transmitting prompts or model outputs

Each persona-policy pack (162) may include memory-retrieval-constraint fields (312) that define a maximum retrieval depth, allowable sensitivity classifications, and rules for token-budgeted inclusion of contextual memory items retrieved from the user-context store (140).

Each persona-policy pack (162) may include tone-and-style-modulation parameters (318) that specify stylistic attributes such as formality level, hedging level, tone bias, and persona-specific voice characteristics. These parameters may be applied during prompt composition to normalize or modulate the language style of generated responses.

Each persona-policy pack (162) may include safety-and-escalation-rule definitions (320) that specify numeric or logical thresholds for computed risk scores (r) and corresponding escalation actions. Escalation actions may include invoking predefined emergency message templates or notifying designated human contacts identified within the user's consent scope.

By defining each of the foregoing parameters in a structured and machine-readable format, the guardian-persona layer (160) enables deterministic parsing, validation, and enforcement of behavioral policies, thereby providing reproducible, auditable, and adaptable control over language-model output generation.

During operation, an adaptive-persona selector (164) may evaluate the current user-state vector (142) together with a computed risk score r∈[0, 1] against stored policy-pack conditions. Based on threshold comparisons (for example, r≥T₁ or r≥T₂), the middleware may select an appropriate persona-policy pack (162) such as protective, reflective, or encouraging and embed its policy_id (314) into the control segment (174). The persona selector thereby enforces context-appropriate behavioral constraints prior to prompt generation.

The policy packs (162) may be updated dynamically or version-controlled to allow administrators to adjust safety and behavioral parameters without retraining the underlying LLM (150). When applied, the selected policy pack determines decoding configuration values, permissible memory-recall scope, and tone-conditioning parameters that govern the middleware's construction of the conditioned input sequence. Versioning of policy packs enables reproducible auditing and rollback of prior configurations.

A risk-scoring module (166) may evaluate multimodal signals and conversational features to compute a normalized risk score r. In one embodiment, a weighted formula combines sentiment polarity from textual content, arousal indices from physiological sensors, and historical indicators of crisis behavior. When the score exceeds a first threshold T₁, the middleware automatically selects the protective persona and restricts private-memory recall. When the score exceeds a higher threshold T₂, the middleware may escalate by notifying a designated human contact such as a caregiver or counselor identified within the user's consent scope (320). In alternative implementations, escalation may invoke integrations with third-party systems such as telehealth platforms or emergency-response APIs. The risk-evaluation component continuously computes r using a rule-based or machine-learned classifier applied to the user's conversational and physiological features. The computed risk score triggers parameterized responses based on the configured thresholds T₁ and T₂, where 0≤T₁<T₂≤1. If r≥T₁, the system embeds a protective-persona identifier into the control segment (174) and reduces decoding variance and memory-retrieval depth. If r≥T₂, the middleware transmits a notification to the designated contact and may suppress free-form generation in favor of a templated emergency message. These operations ensure deterministic, policy-bound control of model behavior across user states and risk conditions, as illustrated in FIGS. 7A and 7B.

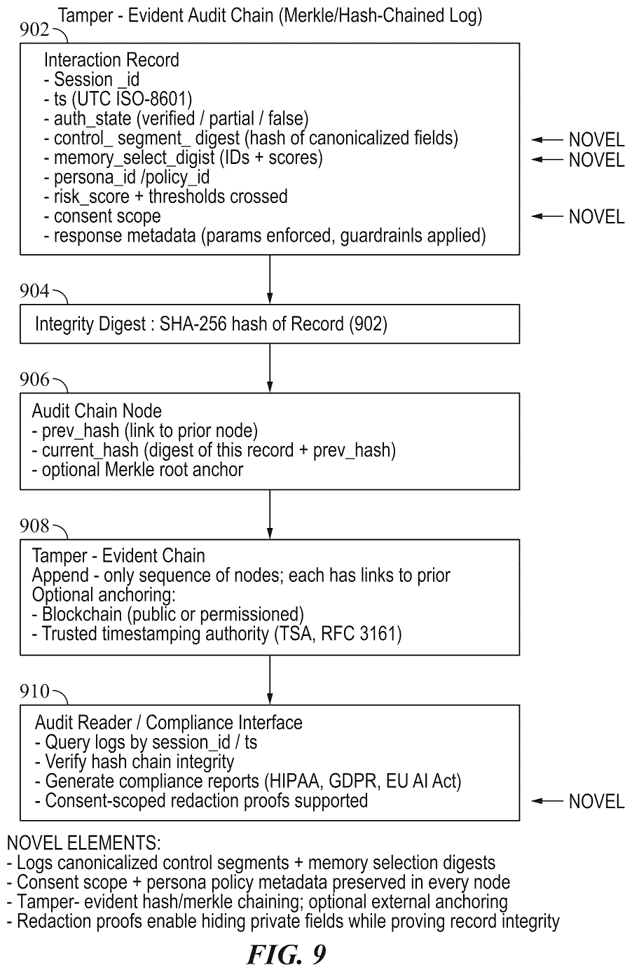

Each interaction processed by the middleware may generate an audit record (790) that includes digests of the control segment (176), selected memory identifiers and salience digests (182), computed risk scores (r), and the applicable consent scope (320). Successive audit records may be linked through a hash-chain or Merkle-tree structure (792) to provide tamper evidence and chronological ordering. A rolling root hash of the chain may be periodically anchored to an external trust service (902)—for example, a blockchain ledger or trusted-timestamp authority—to furnish independent proof of integrity. A compliance interface may enable authorized auditors to verify inclusion or exclusion proofs, supporting selective redaction of sensitive entries while maintaining the integrity of the overall chain. In some embodiments, the audit-chain data may be stored in a distributed file system (e.g., IPFS-class network) to provide redundancy and resilience against single-node failure, as illustrated in FIGS. 7A, 7B, and 9.

External LLM API Integration: In one embodiment, the middleware transmits the conditioned input sequence (172) to an external LLM service (150) via a RESTful HTTPS API using the following exemplary protocol and message format: POST https://api.llm-provider.com/v1/chat/completions Headers: Authorization: Bearer {api_key} Content-Type: application/json X-Control-Segment-Digest: {base64-encoded-SHA256-digest-176} X-Middleware-Session-ID: {session_identifier} Body: {“model”: “gpt-4”, “messages”: [{“role”: “system”, “content”: “{serialized_control_segment_174_as_text}”}, {“role”: “user”, “content”: “{user_message_176_with_selected_memories}”], “temperature”: {value_from_PARAMS_316}, “max_tokens”: {value_from_PARAMS_316}, “top_p”: {value_from_PARAMS_316}, “stop”: {stop_sequences_from_PARAMS_316}} The control segment (174) is serialized as a human-readable text string or structured JSON object and embedded in the system message role, ensuring that the external LLM conditions its response according to the encoded authentication state, user-state vector, persona policy, and parameter overrides. The X-Control-Segment-Digest header contains a SHA-256 hash of the canonical control segment (176), enabling optional integrity verification by the receiving service or intermediate gateways. The API response is received as a JSON object containing the generated text, token counts, and optional metadata, which the middleware then processes through the validation module (190) and persona-based post-processing (160) before returning to the user. Alternative embodiments may use gRPC with Protocol Buffer message encoding, WebSocket connections for streaming responses, or server-sent events (SSE) for real-time token delivery. For on-premises or self-hosted LLM deployments, the middleware may invoke local inference endpoints using JSON-RPC, REST APIs exposed by frameworks such as vLLM, TGI (Text Generation Inference), or Ollama, or direct Python function calls when the middleware and LLM share the same runtime environment. In distributed deployments, the middleware may employ load balancers, API gateways (e.g., Kong, Apigee), or service meshes (e.g., Istio, Linkerd) to route requests to multiple LLM instances based on availability, latency, or cost optimization criteria. The middleware logs the complete request and response cycle, including timestamps, token counts, and any error conditions, into the audit chain (790) for compliance and debugging purposes.

The external large-language-model service (150) may process only the conditioned sequences (172) that have been generated and validated by the middleware. In one embodiment, the middleware may embed policy settings within the textual prompt so that the external service's output reflects the applied persona configuration; however, the service itself does not authenticate or interpret the control-segment signature. In another embodiment, an API gateway positioned between the middleware and the model may parse limited header information to enforce size or safety constraints before forwarding the user-message segment (172) to the model. The external service remains stateless and does not persist private context, relying exclusively on the middleware to supply the minimal, policy-filtered information required for generation. Alternative implementations may integrate with commercial or open-source LLM platforms, including but not limited to OpenAI-, Anthropic-, or on-premises-deployed transformer models.

Various embodiments of the present invention relate to improvements in middleware architectures for conversational artificial-intelligence systems. The disclosed technology includes, at a middleware service, validating a cryptographic attestation associated with a user, the attestation comprising freshness metadata including at least a nonce and an expiration value; denying, by default, retrieval of private conversational memory unless the attestation is validated as fresh; upon validation, selecting candidate memories from a user-context store (140), each memory annotated with sensitivity and time-to-live metadata, wherein selection is performed by a deterministic salience function combining semantic similarity, term specificity, and temporal recency decay, and wherein identifiers and scores of selected memories are cryptographically hashed into an audit digest (182). The middleware further constructs a canonical, machine-parsable control segment (174), separate from the user message, encoding at least an authentication state, a user-state vector, a policy identifier, parameter overrides, a consent scope, and integrity metadata comprising a digital signature (322). The middleware validates the control segment's integrity, signature, and freshness prior to transmission, then assembles a conditioned input sequence (172) composed of the validated control segment and the user message augmented with the selected memories. Metadata for each interaction are logged in a tamper-evident audit chain (790) linking the audit digest and the control-segment digest (176) across sessions. These operations are inherently computer-implemented and cannot be performed in the human mind. The present invention amounts to significantly more than the mere use of a generic computer to collect and display data, because the disclosed steps improve the functioning of computer systems that mediate large-language-model interactions. Specifically, the disclosed middleware introduces structured authentication, memory management, and policy enforcement mechanisms that conventional conversational systems lack. Unlike prior approaches that recall conversational history directly or rely on unstructured metadata, the disclosed system (i) validates a cryptographic attestation before granting memory access, (ii) applies a deterministic salience function to select only the most relevant records within a defined token budget, and (iii) encodes authentication state, user-state vectors, and policy identifiers in a canonical control segment. Adaptive persona-policy packs (162) dynamically adjust model behavior based on user risk scores, consent scope, and longitudinal context, replacing static filters with machine-enforceable policies. Each interaction generates a tamper-evident audit record, enabling compliance and verifiability beyond what transcript logs can provide. Together, these features yield controlled, authenticated, and auditable conditioning of large-language-model interactions while improving efficiency, consistency, and safety. The disclosed steps cannot be practically performed on pen and paper or by mental processes because they involve high-throughput, real-time cryptographic validation and continuous network communication of structured data. Accordingly, the invention represents a technological improvement in the operation of computer systems and cannot be characterized as a mere method of organizing human activity

Implementations of the present invention may include executing, running, or deploying one or more artificial-intelligence models on a computing device or distributed computing environment. The computing device executes the algorithms and mathematical functions of the artificial-intelligence model on computer hardware such as one or more central-processing units (CPUs), graphics-processing units (GPUs), or tensor-processing units (TPUs)—using appropriate machine-learning libraries. The computing device implements the artificial-intelligence model when it performs operations such as training, inference, prediction, classification, or generation of model outputs from input data. The rate at which these models analyze and transform data to effectuate the disclosed middleware methods, systems, or products involves large-scale, continuous transformation of structured and unstructured data. Accordingly, the present invention cannot be accomplished on pen and paper or in the human mind because it requires real-time, high-throughput numerical computation and continuous digital communication between hardware components.

FIG. 1 illustrates an example middleware architecture (100) configured for authenticated, context-conditioned, and auditable interactions with an external stateless large-language-model (LLM) service (150). The architecture operates as a coordinated set of modules that enforce authentication, context selection, persona policy, and auditability before any data are transmitted to the LLM.

A user (101) may interact through a user-input interface (110), which receives natural-language messages and forwards them to an authentication-and-attestation module (120). The authentication-and-attestation module (120) obtains an attestation token (122) derived from one or more biometric, sensor-based, or cryptographic sources and validates the attestation within the middleware. The validated attestation may include a verification status, a method identifier, freshness metadata such as a nonce and expiration timestamp, and the token itself. Only upon successful validation does the middleware permit access to private conversational memory.

Authenticated access enables controlled interaction with a user-context store (140), which maintains structured records including conversation summaries (142), affective-state data (144), and policy metadata (146). Private context slices may be locked or gated by the attestation token (122) so that access is permitted only when the token has been verified as fresh and valid. Each record may further include sensitivity and retention metadata defining allowable recall conditions.

A signal-ingestion module (130) collects multimodal physiological or behavioral signals from user-associated devices such as wearables, mobile sensors, or Internet-of-Things (IoT) endpoints. These signals are provided to a context-synthesis engine (160), which computes a user-state vector (162) representing real-time contextual and affective conditions of the user. The vector may include numerical and categorical features that are later incorporated into the control segment (174) for prompt conditioning.

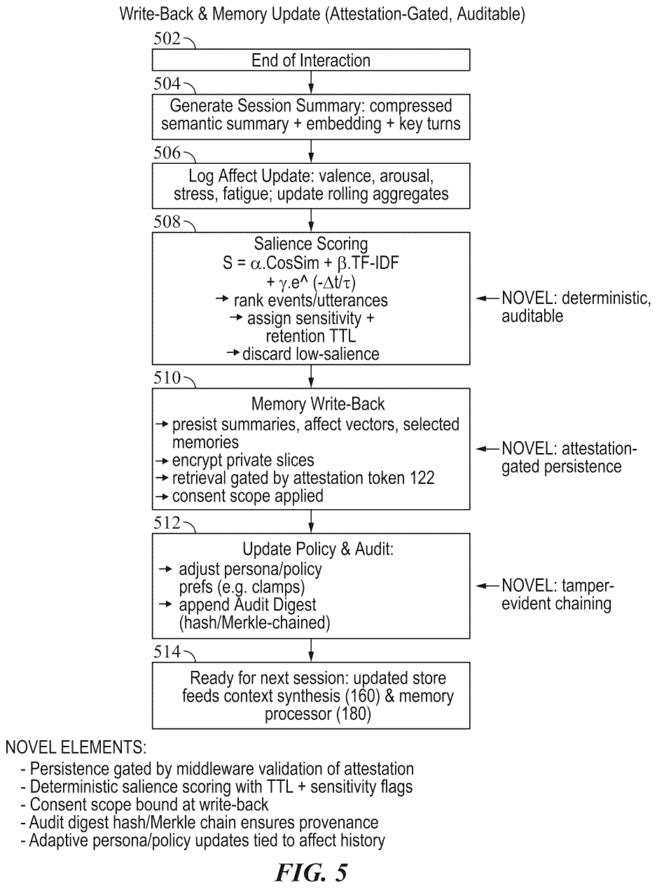

A memory processor (180) performs deterministic salience scoring on candidate memory records retrieved from the user-context store (140). In one embodiment, the salience score is computed according to a weighted function: salience=α·CosSim+β·TF-IDF+γ·e\hat{ }(−Δt/τ), where CosSim denotes the cosine similarity between embeddings of the current query and candidate record, TF-IDF represents term-specific weighting, and the exponential-decay term provides temporal recency weighting. The memory processor (180) ranks candidate records by their computed salience values, selects those within a predefined token-budget limit, and outputs the selected memories together with an audit digest (182) formed by hashing record identifiers and corresponding salience scores. This digest contributes to the tamper-evident audit chain (790) described in FIGS. 5, 7A, and 7B.

A prompt-composition engine (170) receives the selected memories and the user-state vector (162) and constructs a conditioned input sequence (172) for transmission to the external LLM service (150). The sequence includes two logical components:
(i) a control segment (174) encoding fields such as authentication state, user-state vector, active policy identifier (314), model-parameter overrides, consent scope (320), and integrity metadata containing a cryptographic signature (322); and
(ii) a user-message segment (176) containing the user's natural-language input combined with the selected contextual memories. The control segment is validated and consumed exclusively within the middleware prior to transmission, ensuring that only the conditioned textual prompt reaches the external LLM. The relationship of these elements is further illustrated in FIG. 3 and FIG. 5.

Before transmission, a validation module (190) of the middleware verifies the integrity, digital signature (322), and freshness metadata (304) of the control segment (174) to ensure authenticity and compliance with canonical serialization rules. If all checks succeed, the conditioned-input sequence (172) is transmitted to the external stateless LLM service (150). The LLM processes the received textual prompt without modifying or interpreting the control segment and does not perform any authentication or cryptographic verification; all validation and enforcement occur within the middleware layer.

The middleware architecture (100) thereby enables attestation-gated recall, deterministic context selection, canonical control-segment generation, and verifiable end-to-end interaction integrity between a user and an external large-language-model service, as shown in FIG. 1.

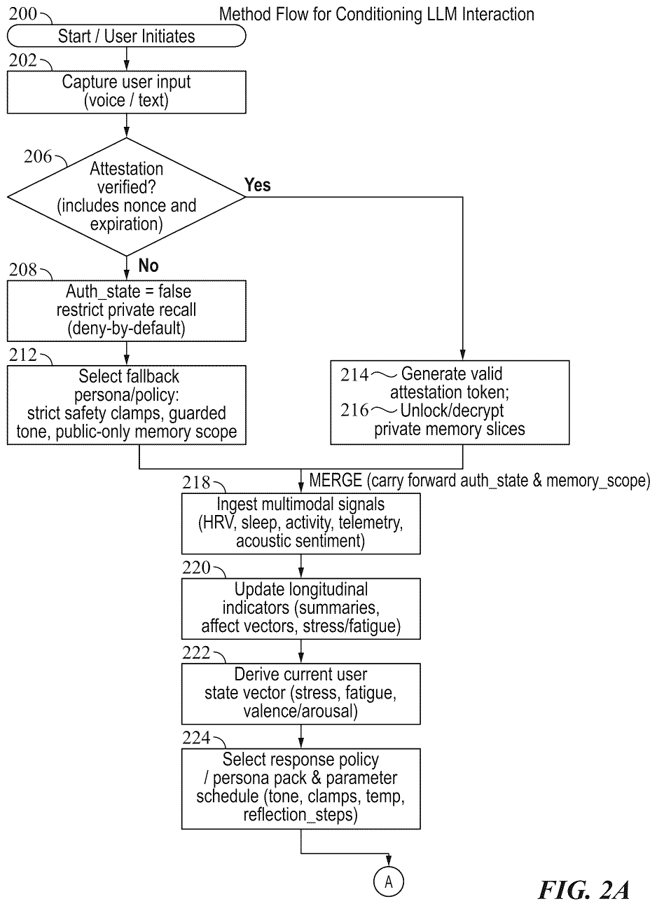

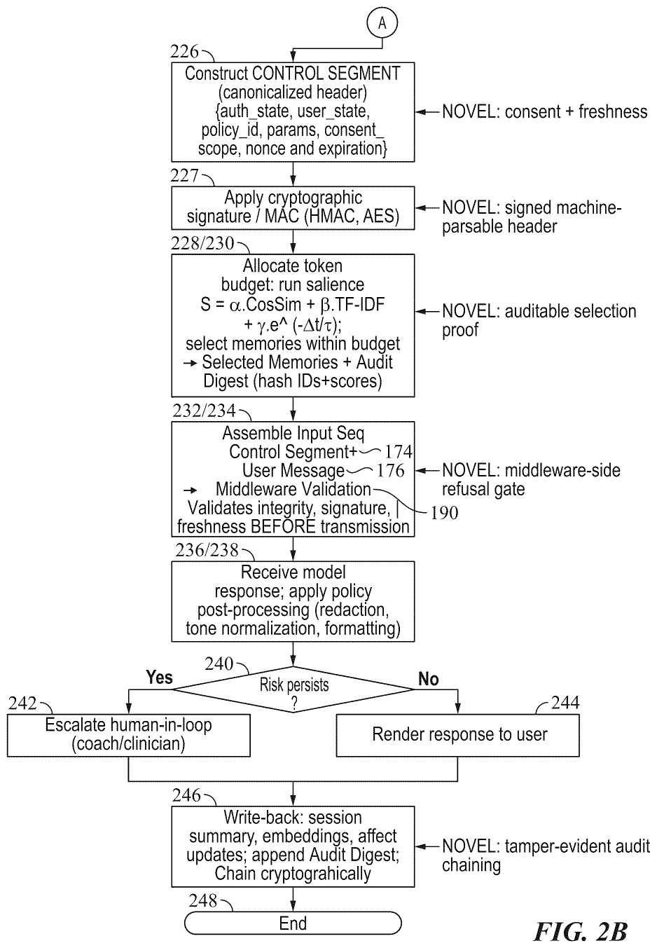

FIG. 2A illustrates a portion of a method flow (200) for conditioning an interaction with a large-language-model service using middleware controls. At step 200, a new session begins when a user (101) initiates an interaction through the user-input interface (110). At step 202, the user-input interface captures the user's natural-language input in voice or text form and forwards the captured message to the middleware architecture (100) for processing. The middleware may also attach metadata such as a timestamp, input-source identifier, or device information to the message for later inclusion within the control segment (174).

At decision 206, the middleware determines whether an attestation (122) associated with the user has been successfully verified, the attestation including freshness metadata (304) such as a nonce and an expiration timestamp. When verification fails, the flow proceeds to step 208, where the middleware sets the authentication state to false and restricts retrieval of private conversational memory in accordance with a deny-by-default policy. At step 212, the middleware applies a fallback persona or policy pack (162) that enforces strict safety constraints, guarded tone, and a public-only memory scope, thereby permitting limited interaction while maintaining compliance and user protection.

When the attestation (122) is successfully verified, the flow proceeds to step 214, where the authentication-and-attestation module (120) generates or accepts a valid attestation token and confirms the authenticated session. At step 216, private-memory slices within the user-context store (140) are unlocked or decrypted for potential recall subject to their sensitivity and time-to-live metadata. The verified and unverified branches converge at step 218, which merges processing while retaining the current authentication state and corresponding memory-access scope.

Continuing at step 218, the signal-ingestion module (130) acquires multimodal signals from user-associated devices, including but not limited to heart-rate variability, sleep metrics, activity and telemetry data, and acoustic-sentiment features. At step 220, longitudinal indicators maintained in the user-context store (140) such as conversation summaries, affect vectors, and stress or fatigue markers are updated. At step 222, a context-synthesis engine (160) derives a current user-state vector (162) encoding affective attributes such as stress, fatigue, and valence or arousal. At step 224, the guardian-persona layer (160) selects an appropriate persona-policy pack (162) and associated parameter schedule (for example, tone controls, safety clamps, decoding temperature, and reflection-step limits). The flow then continues as indicated by connector A, leading to FIG. 2B.

FIG. 2B continues the method flow (200) for conditioning an interaction with a large-language-model service from connector A of FIG. 2A. At step 226, a prompt-composition engine (170) constructs a control segment (174) formatted as a canonical, machine-parsable header. The control segment encodes fields indicative of the current authentication state (306), the user-state vector (310/162), an active policy identifier (314), model-parameter overrides (316), a consent scope (320), and freshness metadata including a nonce and expiration timestamp (304). At step 227, the middleware applies a cryptographic signature or message-authentication code (322) over the canonical serialization of the control-segment fields, thereby producing an authenticated control record ready for validation by the middleware's internal integrity checker.

At steps 228 and 230, the memory processor (180) allocates a defined token-budget limit (B) and executes a deterministic salience procedure over candidate memories retrieved from the user-context store (140). The middleware computes a salience score for each candidate record according to the weighted function: S=α·CosSim+β·TF-IDF+γ·e\hat{ }(−Δt/τ) where CosSim represents semantic similarity between embeddings, TF-IDF denotes term specificity, and the exponential-decay factor applies temporal weighting based on record age. The middleware selects the highest-scoring records that fit within the token-budget constraint and outputs the selected memories together with an audit digest (182) formed by hashing record identifiers and corresponding scores for subsequent inclusion in the audit chain (790).

At steps 232 and 234, the middleware assembles a conditioned-input sequence (172) comprising the signed control segment (174) and a user-message segment (176) that includes the user's natural-language content combined with the salience-selected memories. A validation module (190) then verifies prior to transmission the integrity, digital signature (322), and freshness metadata (304) of the control segment to ensure authenticity and canonical ordering. Upon successful validation, the conditioned sequence is transmitted to the external stateless LLM service (150) for inference.

At steps 236 and 238, the middleware receives the model's generated response and applies policy-based post-processing, which may include redaction of sensitive text, tone normalization, and output formatting in accordance with the active persona-policy pack (162). At decision 240, the middleware determines whether a risk condition continues to exist based on the updated risk scoring module (166). If the condition persists, step 242 initiates escalation to a human-in-the-loop resource such as a coach, counselor, or clinician identified within the user's consent scope (320). If no elevated risk is detected, step 244 renders the moderated response to the user (101), concluding the interaction cycle illustrated in FIG. 2B.

At step 246, the middleware performs write-back operations that finalize the session. These operations include generating a session summary, updating embeddings and affective indicators within the user-context store (140), appending the newly computed audit digest (182), and chaining a new audit record (790) cryptographically to the prior record in the audit chain (792). The method terminates at step 248, completing the interaction cycle shown in FIG. 2B.

FIG. 3 depicts an example control segment (174) implemented as a canonicalized, machine-parsable, and cryptographically signed header that conditions interactions with a language model. The control segment includes a VERSION and TIMESTAMP field (302), which identify the schema version and an ISO-8601 timestamp marking when the segment was created. An AUTH field (306) encodes an authentication state derived from a validated attestation, including a verification flag, method identifier, attestation token, and freshness metadata such as a nonce and expiration timestamp; this field enforces a deny-by-default behavior for private-memory recall when freshness is not validated. A DEVICE field (308) specifies a device identifier, device class, and signal-quality metrics. A STATE field (310) carries a user-state vector (162) that may include affective variables such as valence, arousal, stress, fatigue, and confidence. A MEMORY_SELECT field (312) lists selected memory keys together with sensitivity flags and time-to-live values, and identifiers and salience scores are cryptographically committed via an audit digest (182). If attestation freshness validation fails, the middleware sets authentication_state to false and invokes a restricted fallback persona for low-sensitivity responses. A POLICY field (314) references an active persona or policy identifier obtained from the guardian-persona layer (160). A PARAMS field (316) defines model-parameter overrides such as temperature, max -tokens, reflection_steps, tone settings, safety profile, and token_budget, all of which are enforced as part of the signed control pack. A RISK_FLAGS field (318) indicates elevated stress, unsafe intent, or partial-authentication conditions. A CONSENT field (320) specifies permissions governing the storage of private data, communication with a designated human contact, or analytics usage, and this field is cryptographically bound to the segment. A SIG field (322) includes an algorithm identifier, key identifier, and the cryptographic signature or message-authentication code computed over the canonicalized fields, thereby enabling middleware validation of integrity and freshness prior to transmission. An EXT field (324) reserves space for future extensions, such as specifying an audit-anchoring target service. Collectively, these fields define the canonical schema used by the middleware to standardize, validate, and audit every interaction prior to engagement with the external LLM (150).

Cryptographic Signature Implementation: In one embodiment, the cryptographic signature (322) is generated using the Ed25519 signature algorithm over a canonicalized representation of the control-segment fields. Canonicalization is performed according to JSON Canonical Form as specified in RFC 8785, ensuring deterministic byte-string representation regardless of field ordering in memory. The middleware maintains a public-private key pair, with the private key stored in a hardware security module (HSM), secure enclave (e.g., Intel SGX, ARM TrustZone, or Apple Secure Enclave), or trusted platform module (TPM). The public key is distributed to validation endpoints and may be registered in a certificate authority or key-distribution service. Signature generation involves the following steps: (1) serializing control-segment fields {VERSION, TIMESTAMP, AUTH, DEVICE, STATE, MEMORY_SELECT, POLICY, PARAMS, RISK_FLAGS, CONSENT} in canonical JSON order as defined by RFC 8785; (2) computing a SHA-512 hash of the canonical byte string; (3) signing the hash using the Ed25519 private key according to RFC 8032; and (4) embedding the resulting signature in the SIG field (322) along with an algorithm identifier (e.g., “Ed25519”) and a key identifier (kid) referencing the signing key. The middleware validates signatures upon receipt by recomputing the canonical serialization, hashing the byte string, and verifying the signature using the corresponding public key. Alternative embodiments may use ECDSA with NIST curve P-256 or P-384, RSA-PSS with 3072-bit or 4096-bit keys, or HMAC-SHA 256 with symmetric keys derived via password-based key-derivation functions such as PBKDF2, scrypt, or Argon2. The choice of algorithm may be negotiated based on device capabilities, with mobile devices preferring Ed25519 for performance and enterprise systems using RSA for compatibility with existing public-key infrastructure.

As shown in FIG. 3, the control segment (174) is positioned within the conditioned-input sequence (172) alongside a user-message segment (176) that contains the user's free-text content. Prior to any transmission, the middleware validates the control segment's integrity, signature, and freshness to confirm authenticity and canonical ordering before forwarding the conditioned sequence to the external LLM service (150) for inference.

FIG. 4 illustrates a middleware-enforced memory-gating flow (400) based on attestation. At step 402, user input is received by the middleware (100) through the user-input interface (110). At decision 404, the middleware determines whether an attestation (122) associated with the user is valid and fresh in accordance with its embedded nonce and expiration timestamp (304). Validation is performed by the authentication-and-attestation module (120) using cryptographic verification against stored keys and policy conditions.

If the attestation (122) is not valid, the flow proceeds to step 406, in which private-memory partitions remain locked and an encrypted authentication state within the control segment (174) indicates false. At step 408, the middleware (100) restricts contextual recall to public-only data, such that the MEMORY_SELECT field (312) is empty or limited to downgraded, non-sensitive items. At step 410, the middleware applies a fallback persona policy (162) that enforces restricted decoding parameters, guarded-tone generation, and strict safety clamps, thereby allowing minimal interaction while maintaining compliance with the deny-by-default policy.

If the attestation (122) is valid, the flow proceeds to step 412, where private-memory slices within the user-context store (140) are unlocked or decrypted and the authentication state (306) is set to true. At step 414, both public and private candidate memories become eligible for recall and are ranked using salience recency scoring performed by the memory processor (180). Selected identifiers, together with associated sensitivity flags and time-to-live values, are written to the MEMORY_SELECT field (312) and cryptographically committed via an audit digest (182). At step 416, an adaptive persona-policy pack (162) is applied to enforce model-parameter overrides, consent-scope limits, and safety constraints consistent with the verified authentication state and user context.

At step 418, a context-synthesis engine (160) derives a current user-state vector (162), which is encoded into the downstream control segment (174) for subsequent interactions. FIG. 4 further highlights the novel elements of the middleware, including deny-by-default gating triggered upon failed attestation, canonicalized MEMORY_SELECT entries (312) containing identifiers with sensitivity and time-to-live metadata hashed into an audit digest (182), enforceable persona-policy packs (162) in place of free-text tone instructions, and a consent scope (320) that is cryptographically bound to each gating decision. These components collectively ensure authenticated, deterministic, and auditable conditioning of language-model interactions.

FIG. 5 illustrates a write-back and memory-update flow (500) that is attestation-gated and fully auditable. The flow begins at step 502 upon termination of an interaction session. At step 504, the middleware (100) generates a session summary comprising a compressed semantic synopsis, an embedding representation, and identifiers of key conversational turns derived from the prior session. At step 506, the middleware logs affective information by updating rolling indicators such as valence, arousal, stress, and fatigue, thereby maintaining longitudinal affect tracking for future context synthesis and risk evaluation.

At step 508, the middleware executes a deterministic salience procedure that ranks session events and utterances using a composite scoring function defined as S=α·CosSim+β·TF-IDF+γ·e\hat{ }(−Δt/τ) Each event may be assigned sensitivity flags and retention time-to-live (TTL) values, and content falling below a minimum salience threshold may be discarded. At step 510, the middleware performs memory write-back by persisting the session summary, updated affective vectors, and selected memories to the user-context store (140). Private data slices may be encrypted, and retrieval of private items remains gated by a validated attestation token (122). The consent scope (320) is enforced at the time of write-back to ensure that stored data complies with the user's permissions and privacy settings.

At step 512, policy and audit records are updated. Persona and policy parameters such as safety clamps, tone configurations, or reflection-depth limits may be adaptively adjusted based on observed outcomes. A new audit digest (182) is appended and cryptographically chained to the previous record through a hash or Merkle link (792) to provide tamper evidence. At step 514, the user-context store (140) is prepared for the next session, providing updated inputs to the context-synthesis engine (160) and memory processor (180). FIG. 5 highlights novel aspects of the invention, including middleware-validated persistence, deterministic salience ranking incorporating TTL and sensitivity flags, consent-bound write-back, tamper-evident audit chaining, and adaptive persona and policy updates tied to longitudinal affect history.

FIG. 6 illustrates an example system environment (600) and a longitudinal-affect heat-map pipeline that is attestation-gated and consent-aware. A user (602) interacts through multiple endpoints, including wearable devices (604) that provide physiological measures such as heart-rate variability, sleep metrics, and movement data; a smartphone (606) providing a user interface, microphone input, and location services; and other Internet-of-Things (IoT) devices (608) such as smart speakers, home assistants, or in-vehicle infotainment systems. These endpoints communicate securely with a MiAngel middleware system (610) over authenticated network channels, enabling synchronized ingestion of multimodal data under the user's verified attestation and consent scope.

Within the middleware system (610), a signal-ingestion module (130) receives and normalizes multimodal telemetry subject to attestation gating, while an authentication-and-attestation module (120) validates the user's cryptographic attestation (122) and associated freshness metadata. A user-context store (140) maintains longitudinal records of prior interactions, wherein private slices remain locked unless attestation is verified. A context-synthesis engine (160) derives a dynamic user-state vector (162) from both the ingested signals and historical records. A prompt-composition engine (170) then prepares conditioned input sequences (172) for model processing, and a guardian-persona layer (616) applies enforceable policy packs (162) that constrain model parameters, memory-recall depth, and tone according to the validated consent scope and computed risk conditions. Together, these components generate a longitudinal-affect heat-map (618) representing evolving emotional and physiological states over time.

The environment may further include a secure-cloud-storage service (612) that maintains encrypted backups of longitudinal user records. From the user-context store (140) and the user-state vector (162), the middleware (610) generates a longitudinal-affect heat-map (618) that plots affective dimensions, such as valence and arousal, as a function of time. Data points are produced only from sessions having validated attestations (122), and the applicable consent scope (320) governs whether private slices are included in the visualization. Each plotted vector is linked to a corresponding audit digest (182) to provide cryptographic provenance. The pipeline interfaces with an external, stateless LLM service (614) via an authenticated application-programming interface (API) and returns user output (618) in text, audio, or graphical-user-interface form. The heat-map renderer may support smoothing, missing-data shading, and contextual event annotations, all performed within the boundaries of the user's consent scope. Identifiers and their computed salience scores are concatenated and hashed using a secure algorithm such as SHA-256 to produce the audit digest, which is then linked to the canonical control-segment digest (176) within the tamper-evident audit chain (790). This linkage provides cryptographic proof of what contextual records were selected and the rationale for their inclusion.

FIG. 7A illustrates a risk-escalation policy flow (700) that is attestation-linked and consent-aware. At step 702, the middleware (610) continuously monitors the user's affective state and ongoing conversational context. The monitored signals may include affect-vector components such as valence, arousal, stress, and fatigue, as well as semantic cues indicative of crisis intent and partial-authentication device signals. Metadata derived from the control segment (174) provides contextual grounding for these observations. The canonical control segment is serialized using deterministic encoding schemas such as JSON Canonical Schema (JCS), CBOR, or Protocol Buffers and cryptographically signed using algorithms such as Ed25519 or ECDSA P-256 to ensure structural integrity and authenticity throughout the risk-evaluation process.

At step 704, one or more risk classifiers (166) are applied by the middleware (610) to the monitored conversational and physiological features. These classifiers may include rule-based or pattern-matching detectors, statistical anomaly detectors, and machine-learned models such as sequential, linguistic, or acoustic classifiers trained to identify indicators of elevated distress, unsafe intent, or potential crisis conditions. Classifier outputs are combined into a unified inference stream for risk-score computation.

At step 706, the middleware computes a normalized risk score (r) within the closed interval [0, 1] and compares it to configurable threshold values T₁ (elevated) and T₂ (critical). Thresholds may be statically defined or dynamically adjusted based on historical user baselines, contextual time windows, or clinician-approved configuration profiles stored in the policy pack (162). The resulting comparison determines whether escalation logic is triggered.

If r<T₁, the flow proceeds to step 708, continuing a normal guardian flow that maintains full feature access and standard interaction privileges under the currently active persona-policy pack (162). The middleware records the non-elevated state in the audit chain (790) for traceability and resumes ordinary conversational processing without initiating any escalation event.

If r≥T₁, the flow advances to step 710, in which the middleware (610) dynamically adapts the active persona-policy pack (162) by activating a protective persona configuration. In this state, the middleware reduces model-decoding variance by lowering generation parameters such as temperature and top_p, enforces mandatory clarifying-question prompts, and restricts memory-retrieval depth to minimize potential exposure of sensitive content. These adaptive constraints remain in effect until the user's computed risk score returns below the elevated threshold.

The process then proceeds to a decision branch (connector A) in which the risk score (r) is further compared against the critical threshold (T₂) to determine whether escalation to a designated human contact or support service is required. When r≥T₂, the middleware invokes the escalation logic described in FIG. 7B; otherwise, the session continues under protective-mode parameters until risk normalization occurs.

FIG. 7A emphasizes the novel use of control-segment metadata (174) to associate real-time risk assessment with verified attestation (122) and consent scope (320), thereby enabling tiered policy responses that are grounded in authenticated, continuously updated user-state data. This architecture unifies cryptographic identity, contextual risk analysis, and adaptive persona enforcement within a single, auditable control plane.

FIG. 8 illustrates a guardian-persona layer (802) and associated policy packs (162) that are enforceable and cryptographically signed. The guardian-persona layer (802) orchestrates operational policy by mapping combinations of user-state and risk conditions to predefined persona configurations. Example personas include a protective persona (804) configured for safety-first behavior and crisis mitigation, a reflective persona (806) oriented toward guided journaling and cognitive reframing, and an encouraging persona (808) emphasizing motivation and positive behavioral reinforcement. Each persona policy pack defines parameter boundaries and tone constraints that are deterministically applied by the middleware to control model outputs and memory access in accordance with validated consent and attestation status.

Example Persona-Policy Pack Schema: A persona-policy pack (162) may be defined using the following JSON schema structure, which is validated by the middleware prior to application: {“persona_id”: “guardian.protective.v3”, “version”: “3.0.1”, “issued_at”: “2025-08-15T10:30:00Z”, “expires_at”: “2026-08-15T10:30:00Z”, “signature”: “base 64-encoded-Ed25519-signature”, “signing_key_id”: “key-2025-08-01”, “parameters”: {“temperature”: 0.3, “top_p”: 0.85, “max_tokens”: 150, “token_budget”: 2000, “reflection_steps”:2, “stop_sequences”: [“END”, “STOP”], “presence_penalty”: 0.0, “frequency_penalty”: 0.3}, “guardrails”: {“escalation_triggers”: [“explicit_self_harm”, “crisis_keywords”, “unsafe_intent”], “disallowed_content”: [“medical_diagnosis”, “financial_advice”, “legal_advice”], “tone_constraints”: [“empathetic”, “non-judgmental”, “brief”], “required_disclaimers”: [“I'm an AI assistant, not a licensed professional”], “max_response_length”: 200 }, “memory_constraints”: {“max_retrieval_depth”: 5, “allowed_sensitivity_levels”: [“public”, “low”], “exclude_categories”: [“health_diagnosis”, “financial_transactions”], “minimum_salience_threshold”: 0.4 } “prompt_templates”: {“system_preamble”: “You are a compassionate AI assistant focused on user safety. Prioritize empathetic listening and crisis detection. If you detect elevated risk, encourage the user to speak with a trusted person.”, “safety_preamble”: “SAFETY PROTOCOL: Monitor for self-harm indicators. Escalate if risk score exceeds 0.7. Provide crisis resources if appropriate.”, “response_format”: “Keep responses under 150 words. Use supportive, non-clinical language.”}, “risk_thresholds”: {“T1_elevated”: 0.6, “T2_critical”: 0.8}} The middleware parses this JSON structure, validates the signature (322) using the public key associated with signing_key_id, confirms that the current timestamp falls between issued_at and expires_at, and applies the parameters, guardrails, and memory constraints during prompt composition (170) and validation (190). Each persona-policy pack is cryptographically signed by an administrator or policy-management service to prevent tampering. The middleware maintains a registry of valid signing keys and rejects any policy pack whose signature verification fails or whose expiration timestamp has passed. This structured, machine-readable format enables deterministic parsing, validation, and enforcement of behavioral policies, thereby providing reproducible, auditable, and adaptable control over language-model output generation.

An adaptive-persona selector (810) receives inputs comprising the current user-state vector (162), the normalized risk score (r), and thresholds T₁/T₂ as described in FIGS. 7A and 7B, as well as consent-scope indicators (320) for example, share with human and store private—and the authentication level (306) indicating whether full or partial verification has been achieved. The selector deterministically outputs a persona_id corresponding to a selected policy pack (162), with selection constrained by the active consent scope and attestation validity. The chosen persona governs decoding parameters, tone modulation, and retrieval depth, thereby ensuring that each model interaction reflects both the user's verified identity state and contextual well-being.

A persona-policy pack (812) may be compiled from machine-readable constitution files formatted in JSON or YAML, and each pack may specify configuration parameters that govern both middleware operation and downstream model behavior. These parameters may include model-decoding variables such as temperature, top_p, max_tokens, token_budget, and reflection_steps; guardrail definitions specifying escalation triggers, disallowed phrasing categories, and formatting constraints; prompt-template fields containing system or safety preambles; and memory-constraint settings defining retrieval depth and permissible sensitivity classes. Each persona-policy pack (812) is treated as an enforceable, cryptographically signed bundle rather than an advisory or stylistic tone hint, ensuring deterministic control of behavioral boundaries across sessions.

At step 814, a persona-conditioned prompt is assembled by the middleware (610). The control segment (174) encodes at least the policy identifier (314), parameter overrides (316), consent scope (320), and risk flags (318), while the user-message segment (176) includes the user's natural-language input together with the salience-selected memories (180). The middleware validates the control-segment signature (322) prior to transmission to guarantee integrity and authenticity. An external LLM service (816) operates in a stateless mode and processes the persona-conditioned input without access to private context; in certain embodiments, the receiving service may also verify structural integrity or apply checksum validation. FIG. 8 emphasizes that persona-policy packs are signed, enforceable bundles; persona selection dynamically adapts to state, risk, consent, and authentication; and middleware-level validation ensures that persona and parameter constraints cannot be bypassed.

Audit-Chain Anchoring Protocol: In one embodiment, the middleware anchors aggregated Merkle roots (902) to an external trust service every 1,000 audit records or every 24 hours, whichever occurs first. For blockchain anchoring, the process comprises the following steps: (1) computing a Merkle tree over the 1,000 most recent audit-chain nodes (908), wherein each node contains the interaction record (902) and hash pointers to prior nodes; (2) extracting the Merkle root hash, which serves as a cryptographic commitment to all included records; (3) constructing a blockchain transaction embedding the Merkle root in an OP_RETURN output (for Bitcoin-based chains) or as calldata in a smart-contract function call (for Ethereum-based chains); (4) broadcasting the transaction to the blockchain network (e.g., Bitcoin testnet, Ethereum mainnet, Polygon, or a permissioned blockchain such as Hyperledger Fabric); (5) waiting for transaction confirmation (typically 6 blocks for Bitcoin, 12 blocks for Ethereum) and recording the transaction ID, block height, and block timestamp in the local audit ledger; and (6) storing the transaction receipt and a Merkle proof for each anchored record, enabling subsequent verification that a specific audit record was included in the anchored set. For RFC 3161-compliant trusted timestamping, the middleware performs the following steps: (1) computing the Merkle root as described above; (2) constructing a TimeStampReq message containing the Merkle root hash, hash algorithm identifier (e.g., SHA-256), and a nonce; (3) transmitting the request via HTTP POST to a trusted timestamp authority (TSA) endpoint such as FreeTSA.org, DigiCert TSA, or an enterprise TSA service; (4) receiving a TimeStampResp message containing a signed timestamp token that binds the Merkle root to a UTC timestamp certified by the TSA; (5) validating the timestamp token signature using the TSA's public certificate; and (6) storing the timestamp token alongside the audit record. Verification of anchored records involves: (1) retrieving the blockchain transaction or TSA token associated with the anchoring event; (2) recomputing the Merkle root from the local audit records; (3) comparing the locally computed root to the root embedded in the blockchain transaction or timestamp token; (4) verifying the blockchain transaction remains confirmed (not orphaned) or that the TSA token signature is valid; and (5) confirming that the timestamp falls within the expected chronological window. This anchoring mechanism provides cryptographic proof that audit records existed at a specific point in time and have not been tampered with after anchoring, enabling long-term non-repudiation and regulatory compliance verification even if the local audit database is compromised or corrupted.

FIG. 9 illustrates a tamper-evident audit chain (900) implemented as a hash-or Merkle-chained log. For each middleware session, an interaction record (902) is generated and may include a session identifier, an ISO-8601 timestamp, an authentication state (306) indicating verified, partial, or false status, a control-segment digest (176) computed over canonicalized control-segment fields, a memory-selection digest (182) representing selected identifiers and associated salience scores, a persona or policy identifier (314), a recorded risk score (r) and any thresholds crossed, a consent scope (320), and response metadata describing parameters enforced and guardrails applied during generation. Each audit block therefore contains the control-segment digest, the memory-selection digest, the applied persona identifier, and a timestamp. Successive blocks are cryptographically hash-linked and may be optionally anchored to an RFC 3161-compliant timestamp authority or to a blockchain ledger to achieve long-term non-repudiation and externally verifiable integrity.

At step 904, an integrity digest for example, a SHA-256 hash of the interaction record (902) is computed. At step 906, the middleware forms a new audit-chain node (908) that stores both a reference to the prior node (prev_hash) and a current digest (current_hash) derived from the present record and the previous link. When multiple records are committed together, a Merkle-root anchor (910) may be included to aggregate the batch for efficient verification. This structure enables append-only, tamper-evident logging of all middleware operations and cryptographically links every attestation, control segment, and persona decision across user sessions.

At step 908, individual audit-chain nodes (908) are appended sequentially to produce an append-only, tamper-evident chain, wherein each node references its predecessor through a cryptographic hash pointer. This chaining mechanism ensures chronological ordering and immutability of recorded middleware events. The audit chain may be optionally anchored to an external trust service, such as a public or permissioned blockchain ledger or an RFC 3161-compliant trusted-timestamp authority, to establish independent verification and long-term persistence of integrity proofs across distributed systems.

At step 910, an audit-reader or compliance interface (912) enables authorized queries by session identifier, timestamp, or user context, verifies end-to-end chain integrity, and generates regulatory compliance reports suitable for frameworks such as HIPAA, GDPR, or the EU Artificial Intelligence Act. The interface may further support consent-scoped redaction proofs, allowing the selective concealment of private or sensitive fields while preserving the cryptographically verifiable integrity of the remaining record set. This architecture thereby provides transparent, tamper-evident auditability and policy accountability throughout all middleware operations, as shown in FIG. 9.

FIG. 9 further highlights that the audit chain (900) preserves canonicalized control-segment digests (176) and memory-selection digests (182) together with associated consent-scope (320) and persona metadata (314/162) in every appended node. This configuration provides cryptographically verifiable provenance across user sessions, ensuring that every middleware decision from attestation validation through persona enforcement and context recall remains traceable, auditable, and tamper-evident throughout the system's operational lifecycle.

In the present disclosure, the various embodiments have been described with reference to the flowchart illustrations and block diagrams of the disclosed methods, systems, and computer-program products. It will be understood by those skilled in the art that each block of the flowcharts and block diagrams, and combinations thereof, may be implemented by computer-readable program instructions. Such instructions, when executed by a processor of a general-purpose or special-purpose computer, or other programmable data-processing apparatus, cause the machine to perform the functions described in the corresponding block or blocks. The computer-readable program instructions may be stored in a computer-readable storage medium, which directs a computer or other programmable device to function in a particular manner, thereby constituting an article of manufacture embodying the instructions that implement aspects of the invention. The program instructions may also be loaded into a computer, programmable apparatus, or networked device to cause a series of operational acts that produce a computer-implemented process, such that the executed instructions create specific means for carrying out the functions or acts specified in the flowchart or block-diagram representation of the invention.

In this disclosure, the block diagrams presented in the Figures illustrate the architecture, functionality, and operation of various possible implementations of the disclosed systems, methods, and computer-program products. Each block in the flowchart or block diagrams can represent a module, segment, or portion of instructions comprising one or more executable instructions for implementing the specified logical function or functions. In certain embodiments, the functions noted in the blocks can occur out of the order shown in the Figures. For example, two blocks illustrated in sequence may, in fact, be executed concurrently or substantially concurrently, or the order of execution may be reversed, depending upon the functionality involved. In some embodiments, each block of the flowchart and/or block-diagram illustration, as well as combinations of blocks, may be implemented by a special-purpose hardware-based system configured to perform the specified functions or acts, or by a combination of special-purpose hardware and computer-executable instructions operating together to carry out the invention.

In this disclosure, the subject matter has been described in the general context of computer-executable instructions implemented within a computer program product executed on one or more computing devices. Those skilled in the art will recognize that the disclosed embodiments can be integrated or combined with other program modules. Generally, such program modules include routines, programs, components, and data structures that perform particular tasks and/or implement particular abstract data types. The computer-implemented methods disclosed herein can be practiced with a variety of computer system configurations, including single-processor or multiprocessor systems, mini-computing devices, mainframe computers, handheld computing devices such as smartphones or personal digital assistants (PDAs), and microprocessor-based or programmable consumer and industrial electronics. The illustrated embodiments may also be practiced within distributed computing environments in which tasks are performed by remote processing devices linked through one or more communication networks. In such distributed environments, program modules may reside in both local and remote memory-storage devices, while some embodiments of the invention may likewise operate on stand-alone computing systems without network dependency.

In this disclosure, the terms “component,” “system,” “platform,” “interface,” and the like are intended to refer to, and/or include, a computer-related entity or an entity associated with an operational machine possessing one or more specific functionalities. The disclosed entities may include hardware, a combination of hardware and software, software alone, or software in execution. For example, a component can be a process running on a processor, a processor itself, an object, an executable, a thread of execution, a program, and/or a computer. By way of illustration, both an application running on a server and the server on which it executes can be considered components. One or more components can reside within a single process or thread of execution, or can be distributed across multiple processes or machines. In some embodiments, respective components may execute from various computer-readable media containing corresponding data structures. Components can communicate with each other via local and/or remote processes, for example, by transmitting signals that contain one or more data packets over a local system, a distributed network, or a global communication network such as the Internet. In other examples, a component may represent an apparatus providing specific functionality through mechanical parts operated by electrical or electronic circuitry, wherein the circuitry is driven by software or firmware executed by a processor. The processor may be internal or external to the apparatus and may execute at least part of the corresponding software or firmware. Alternatively, a component may consist solely of electronic elements that implement specific functionality through circuit-level logic or embedded firmware without mechanical parts. In still other embodiments, a component may emulate physical hardware via a virtual machine or containerized environment, such as those deployed within a cloud computing platform, thereby providing equivalent functionality in a virtualized execution context.

The phrase “application”, as used herein, refers to software distinct from an operating system, such as word processors, database managers, Internet browsers, and similar end-user programs. Each application generally includes its own user interface (UI) that enables user interaction with the specific program. In most modern operating systems and applications, the user interface is a graphical user interface (GUI) that employs graphical screen elements such as windows (which divide the screen into distinct work areas), icons (which represent computer resources such as files), pull-down menus (which present selectable options), scroll bars (which allow vertical or horizontal navigation within a window), and buttons (which can be activated by a pointer device such as a mouse). Those skilled in the art will recognize that a wide variety of applications and graphical interface paradigms exist, any of which may be used in conjunction with the disclosed embodiments.

The phrases “Application Program Interface” (API) and “API”, as used herein, refer to a defined set of commands, functions, and protocols that computer programmers employ when developing software designed to operate with or upon a specific operating system or software platform. An API provides programmers with predefined functions and interfaces for interacting with system-level resources, thereby eliminating the need to write such functionality from scratch. Common computer operating systems, including Windows, Unix, and macOS, typically expose standardized APIs for developer use. In addition to operating systems, hardware devices that execute software programs also provide APIs to enable programmatic interaction and control. APIs generally simplify software development by offering consistent and reusable interfaces, while also benefiting end users by ensuring that programs built upon the same API framework maintain compatible behaviors and user-interface patterns across applications.

The phrases “computing device” and “central processing unit (CPU)”, as used herein, refer to a computer hardware component that executes individual instructions of a computer software program. A computing device may read program instructions from main memory or secondary storage and execute those instructions sequentially or in parallel until the associated program completes. During execution, the program may generate intermediate or final output that is displayed to an output device such as a monitor, display terminal, or equivalent visual interface. As used herein, the term encompasses physical processors, multicore architectures, and virtualized or emulated processing environments capable of executing computer-readable instructions.

The term “execute,” as used herein in connection with a computer, console, server system, or other programmable apparatus, means to run, use, operate, or carry out an instruction, code segment, software module, or computer program. Execution may occur natively on hardware, within a virtual machine, or in a cloud-based computing environment, and encompasses all forms of machine-implemented operation that perform or enable the functions described in this disclosure.

In this disclosure, the descriptions of the various embodiments have been presented for purposes of illustration and are not intended to be exhaustive or to limit the invention to the embodiments specifically disclosed. Many modifications and variations will be apparent to those of ordinary skill in the art without departing from the scope and spirit of the described embodiments. The terminology employed herein was selected to best explain the principles of the embodiments, to convey the practical applications and technical improvements achieved over existing technologies, and to enable others of ordinary skill in the art to understand and implement the disclosed systems and methods. Accordingly, the appended claims should be construed broadly to encompass other variants and embodiments that may be devised by those skilled in the art.

It will be appreciated by persons skilled in the art that the present invention is not limited to what has been particularly shown and described hereinabove. A variety of modifications, substitutions, and structural or functional equivalents may be made without departing from the scope of the invention as defined by the following claims.

I/We claim:

1. A computer-implemented method for conditioning interactions with a stateless large language model via a middleware control plane executed by one or more processors, comprising:
receiving, from a user device, a natural-language message, validating, at a middleware service comprising one or more processors, a cryptographic attestation associated with the user, the attestation including freshness metadata comprising at least a nonce and an expiration timestamp, denying, by default, retrieval of private conversational memory unless the attestation is verified as fresh within a freshness window not exceeding 90 seconds, selecting, upon successful validation, candidate memory records from a user-context store, each record annotated with sensitivity and time-to-live (TTL) metadata, wherein selection is performed by computing a deterministic salience score according to a weighted-sum function S(i)=α·Sim(E_i, E_t)+β·TFIDF_i−γ·Δt_i, where α, β, and γ are fixed calibration constants, Sim denotes cosine similarity between embedding vectors E_i and E_t, TFIDF_i represents term specificity of record i, and Δt_i represents a temporal interval between record creation and current interaction, and wherein identifiers and corresponding salience scores of selected records are cryptographically hashed to form an audit digest, constructing a canonicalized, machine-parsable control segment separate from the user message, the control segment encoding at least: an authentication state, a user-state vector, a policy identifier, model-parameter overrides, a consent scope, and integrity metadata comprising a cryptographic signature, validating, by the middleware service, the integrity, signature, and freshness of the control segment prior to transmission, assembling a conditioned input sequence for the large language model comprising the validated control segment and the user message augmented with the selected memories, and logging, by the middleware service, metadata of the interaction in an append-only audit chain wherein each record includes a cryptographic hash of a prior record forming a hash-linked sequence, the audit chain cryptographically linking (i) the digest of the canonical control segment and (ii) the digest of the selected memory identifiers and their corresponding salience scores across sessions.

2. The method of claim 1, wherein the control segment is serialized in a canonicalized order comprising at least a version identifier, timestamp, attestation token, user-state vector, and policy identifier, and wherein the integrity metadata comprises a message authentication code or a digital signature.

3. The method of claim 1, further comprising generating, by the one or more processors of the middleware service, session summaries by embedding interaction content using a transformer-based sentence-embedding model, assigning salience scores and retention metadata, and storing the generated summaries in the user-context store for subsequent token-budgeted recall.

4. The method of claim 1, wherein private conversational memory is retrievable only if the attestation is cryptographically validated and remains unexpired, the attestation being derived from at least one of: biometric inputs, device-based sensor signals, or cryptographic credentials.

5. The method of claim 1, further comprising computing, by the middleware, a risk score r within the interval [0, 1] based on multimodal signals and conversational cues, comparing the risk score against configurable thresholds T₁ and T₂ where 0≤T₁<T₂≤1, applying protective persona policies when the risk score exceeds T₁, and, when the risk score exceeds T₂, escalating to a designated human contact specified within the consent scope.

6. The method of claim 1, wherein dynamically switching personas comprises selecting, by the middleware, from a plurality of persona-policy packs stored in the middleware service, the plurality including at least protective, reflective, and encouraging personas, each of the packs specifying decoding-parameter overrides, guardrails, and memory-retrieval constraints.

7. The method of claim 1, wherein the cryptographic attestation includes a nonce and an expiration timestamp, each validated by the middleware within a freshness window not exceeding 90 seconds.

8. The method of claim 1, wherein the canonical control segment, generated by the middleware, comprises fields arranged in a deterministic order including version, timestamp, auth (method, nonce, expiration), state, policy, parameters, consent, and signature.

9. The method of claim 1, wherein the tamper-evident audit chain is periodically anchored, by the middleware, to a public or permissioned blockchain ledger, or to an RFC 3161-compliant timestamp authority.

10. The method of claim 1, wherein when attestation-freshness validation fails, the middleware enforces a restricted fallback persona that limits sensitive recall and modifies response tone, for purposes of safety and regulatory compliance.

11. A system for adaptive conversational middleware, comprising: one or more processors and non-transitory memory storing instructions that, when executed by the one or more processors, implement: a user-input interface configured to receive natural-language messages from a user device, an authentication and attestation module configured to generate and validate cryptographic attestations derived from biometric inputs, sensor-based device signals, or cryptographic credentials, each attestation including freshness metadata comprising a nonce and an expiration timestamp, a signal-ingestion module configured to collect and normalize physiological and behavioral signals from one or more user-associated devices;
a user-context store configured to maintain longitudinal records including conversation summaries, affective-state indicators, and policy metadata, wherein private conversational memory is accessible only upon verified attestation;
a memory processor configured to compute salience scores for candidate memory records using a composite function of semantic similarity, term specificity, and temporal recency decay, to select a token-budgeted subset, and to compute an audit digest of corresponding identifiers and scores;
a state-vector generator configured to derive a current user-state vector from ingested signals and stored records;
a control-segment generator configured to assemble a canonicalized, machine-parsable control segment encoding at least an authentication state, the user-state vector, a policy identifier, parameter overrides, a consent scope, and integrity metadata;
a prompt-composition engine configured to assemble a conditioned input sequence comprising the control segment and the natural-language message augmented with selected memories; and
a validation module configured to verify the integrity, signature, and freshness of the control segment prior to transmission to an external stateless large-language-model service, wherein the external service processes the conditioned input sequence without storing private context.

12. The system of claim 11, wherein the control-segment generator embeds an attestation token that is cryptographically signed with a private key of a middleware key pair, and wherein the validation module is configured to reject control segments that fail signature verification or freshness validation.

13. The system of claim 11, wherein the memory processor is further configured to generate session summaries, by applying a transformer-based embedding model to interaction content, to produce compressed semantic embeddings with assigned salience scores and associated retention metadata.

14. The system of claim 11, wherein the user-context store is configured to restrict retrieval to public records only when attestation is invalid, expired, or absent, thereby preventing access to private conversational memory without verified authentication.

15. The system of claim 11, wherein the state-vector generator is configured to compute a risk score r within the interval [0, 1], the control-segment generator is configured to encode a protective-persona identifier when the risk score exceeds a first threshold T₁, and the system is configured to escalate to a designated human contact specified in the consent scope when the risk score exceeds a higher threshold T₂, where 0≤T₁<T₂≤1.

16. The system of claim 11, wherein the system is configured to maintain a plurality of persona-policy packs, and an adaptive-persona selector is configured to dynamically select one of the packs based on at least one of the user-state vector, risk score, consent scope, or historical interaction patterns.

17. The system of claim 11, wherein the control-segment generator is configured to embed policy identifiers that reference policy-definition files comprising prompt templates, tone rules, escalation thresholds, and memory-retrieval constraints.

18. The system of claim 11, wherein the control-segment generator is configured to compute integrity metadata comprising a cryptographic hash, message-authentication code, or authenticated-encryption tag, and wherein the validation module is configured to enforce a restricted fallback persona that limits sensitive recall and modifies response tone upon validation failure.

19. The system of claim 11, further comprising an audit module that is configured to chain audit records cryptographically, persist a root hash value representing a hash-tree or Merkle-root, and provide proof of inclusion for regulatory or compliance verification.

20. The system of claim 11, wherein the prompt-composition engine is configured to enforce a token budget by including only salience-selected memories determined by the memory processor, thereby reducing computational load and improving the reliability of model responses.

21. A non-transitory computer-readable medium storing instructions that, when executed by one or more processors of a middleware system, cause the one or more processors to perform operations comprising:
receiving, from a user, a natural-language message;
obtaining an authentication attestation derived from at least one of biometric signals, sensor-based device signals, or cryptographic credentials, and determining an authentication state based on validation of freshness metadata comprising at least one of a nonce or an expiration timestamp;
conditioning access to stored conversational memory based on the authentication state by excluding private memory items from retrieval when the authentication state is unverified or partial, and including private memory items when the authentication state indicates verified attestation;
ingesting physiological and behavioral signals from one or more user-associated devices to obtain measurements indicative of a user condition;
maintaining, in a user-context store, longitudinal records comprising at least conversational summaries, affective-state indicators, and policy metadata, each record further including sensitivity tags and retention intervals;
computing salience scores for candidate prior conversational content using a composite salience function combining (i) a measure of semantic similarity, (ii) a measure of term specificity, and (iii) a temporal recency decay, and selecting a subset of memory items subject to a token budget for inclusion in an input to a language model;
deriving a current user-state vector from at least the ingested signals and the user-context store;
generating a canonicalized, machine-parsable control segment, separate from the natural-language message, encoding fields indicative of at least the authentication state, the user-state vector, at least one policy identifier, and one or more model-parameter overrides;
composing a conditioned input sequence comprising the control segment and a user-message segment that includes the natural-language message and the selected subset of memory items; and
validating, by the middleware, the control segment's integrity, signature, and freshness prior to transmission of the conditioned input sequence to an external stateless large-language-model service, wherein the external service processes the conditioned input sequence without modification and returns a response conditioned by the control segment.

22. The non-transitory computer-readable medium of claim 21, wherein generating the machine-parsable control segment further comprises embedding an authentication-attestation token that is cryptographically signed using a private key of a public-private key pair and verifiable with the corresponding public key;
wherein the signature is computed over a canonicalized serialization of control-segment fields including at least the authentication state, the attestation token, and the user-state vector; and
embedding freshness metadata including at least one of a nonce or an expiration timestamp, thereby providing tamper detection and replay protection.

23. The non-transitory computer-readable medium of claim 21, wherein maintaining the user-context store further comprises, after each interaction:
generating a session summary that encodes a compressed semantic representation of the interaction by embedding the interaction content using at least one of: a transformer-based sentence-embedding model or a functionally equivalent embedding model;
computing a salience score for the session summary according to the composite salience function employed for memory selection; and
storing the session summary together with retention metadata comprising at least a sensitivity classification and a time-to-live (TTL) parameter, such that the session summary is eligible for subsequent token-budgeted memory retrieval.

24. The non-transitory computer-readable medium of claim 21, wherein conditioning access to stored conversational memory further comprises:
permitting retrieval of private memory records from the user-context store only when the control segment includes an authentication attestation that is cryptographically validated and within a defined validity interval derived from freshness metadata, the attestation being derived from at least one of biometric signals, sensor-based device signals, or cryptographic credentials; and
restricting retrieval to public records when the authentication attestation is absent, invalid, or expired.

25. The non-transitory computer-readable medium of claim 21, wherein the instructions further cause the one or more processors to:
compute a risk score (r) within the interval [0, 1] from at least the user-state vector and conversational cues using one or more of: rule-based triggers or a machine-learned classifier;
compare the risk score to a first configurable threshold (T₁) and a second, higher configurable threshold (T₂) such that 0≤T₁<T₂≤1;
responsive to r≥T₁, encode in the control segment a protective-persona policy identifier and one or more parameter overrides that reduce decoding variance and restrict memory-retrieval depth; and
responsive to r ≥T₂, transmit a notification to a designated human contact identified in the consent scope, and suppress free-form language-model generation in favor of an emergency-resource message.

26. The non-transitory computer-readable medium of claim 21, wherein generating the machine-parsable control segment further comprises encoding a persona identifier corresponding to a persona-policy pack that is adaptively selected based on at least one of a current user-state vector, a computed risk score, or a consent scope, the persona selected from a set including at least protective, reflective, and encouraging personas; and wherein each persona-policy pack specifies (i) model-parameter overrides including at least one of temperature, top_p, max_tokens, token_budget, or reflection_steps; (ii) guardrails including escalation triggers and phrasing constraints; and (iii) memory-retrieval constraints comprising at least a maximum retrieval depth and allowable sensitivity levels.

27. The non-transitory computer-readable medium of claim 21, wherein generating the machine-parsable control segment further comprises encoding: (i) identifiers of prompt templates including system and safety preambles; (ii) tone-modulation parameters comprising at least one of style, formality, hedging level, or persona-tone rules; and (iii) safety rules comprising at least one of escalation thresholds, disallowed-content classes, redaction or formatting requirements, memory-retrieval sensitivity limits, or tool-and feature-permission constraints; and wherein composing the conditioned input sequence further comprises selecting the referenced prompt templates, applying the tone-modulation parameters and safety rules, and causing application of model-parameter overrides comprising at least one of temperature, top_p, max_tokens, token_budget, stop sequences, presence penalties, frequency penalties, or reflection steps; such that, when processed by the external large-language-model service, the decoding behavior is conditioned according to the encoded policy without modifying the model itself.

28. The non-transitory computer-readable medium of claim 21, wherein generating the machine-parsable control segment further comprises computing an integrity checksum over a canonicalized serialization of control-segment fields and embedding the checksum together with an algorithm identifier into the control segment; and wherein, prior to response generation, at least one of a receiving gateway or an external large-language-model service verifies the checksum, and, responsive to a verification failure, the instructions cause the system to prevent retrieval of private memory and apply a restricted fallback policy.

29. The non-transitory computer-readable medium of claim 21, wherein composing the conditioned input sequence further comprises enforcing a token budget and including, in the conditioned input sequence, only the selected subset of salience-weighted memory items together with the machine-parsable control segment in place of non-selective conversational history;
whereby the average input-token count is reduced relative to a baseline system that omits the control segment and includes non-selective historical context; and wherein the reduction yields at least one of: lower end-to-end latency, reduced compute or energy consumption, lower external-API cost, or reduced hallucination incidence due to exclusion of low-salience or contradictory context, as empirically measured during operation or testing without modification to the external large-language-model.
